(19) United States
(12) Patent Application Publication
(10) Pub. No.: US 2021/0327028 A1
(43) Pub. Date: Oct. 21, 2021

(54) INFORMATION PROCESSING APPARATUS

(71) Applicant: FUJIFILM BUSINESS INNOVATION CORP., Tokyo (JP)

(72) Inventors: Yusuke MACHII, Kanagawa (JP); Yusuke YAMAURA, Kanagawa (JP); Yiou WANG, Kanagawa (JP)

(73) Assignee: FUJIFILM BUSINESS INNOVATION CORP., Tokyo (JP)

(21) Appl. No.: 17/120,770

(22) Filed: Dec. 14, 2020

(30) Foreign Application Priority Data
Apr. 17, 2020 (JP) 2020-073785

(51) Int. Cl. G06T 3/40; G06T 7/11; G06N 3/08

(52) U.S. Cl. CPC G06T 3/4053; G06T 7/11; G06T 3/4046; G06N 3/0454; G06T 2207/20081; G06T 2207/20084; G06N 3/088

(57) ABSTRACT

An information processing apparatus includes a processor configured to perform a resolution reduction process on a target image to generate a low-resolution image, the resolution reduction process being a process in which a degree of resolution reduction changes depending on a size of the target image or a size of dispensable information contained in the target image; and perform a generation process of generating, based on the low-resolution image, a super-resolution image having a predetermined resolution corresponding to a resolution of the target image.

### CROSS-REFERENCE TO RELATED APPLICATIONS

This application is based on and claims priority under 35 USC 119 from Japanese Patent Application No. 2020-073785 filed Apr. 17, 2020.

### BACKGROUND

### (i) Technical Field

The present disclosure relates to an information processing apparatus.

### (ii) Related Art

As techniques for removing or reducing dispensable information contained in an image, there are methods described in Japanese Unexamined Patent Application Publication No. 2019-114821, Japanese Unexamined Patent Application Publication No. 2019-110396, and Japanese Unexamined Patent Application Publication (Translation of PCT Application) No. 2019-530096. In these methods, a region of dispensable information in an image is identified with an algorithm-based technique and the dispensable information in the identified region is removed or reduced.

Super-resolution technologies for increasing the resolution of a low-resolution image are evolving. Recently, the studies and practical use of super-resolution using a deep neural network (DNN) have been in progress. For example, generative adversarial network (GAN)-based super-resolution techniques exemplified by techniques proposed by Ledig, C., Theis, L., et al., “Photo-Realistic Single Image Super-Resolution Using a Generative Adversarial Network”, In: CVPR (2017) and Blau, Yochai, et al., “The 2018 PIRM Challenge on Perceptual Image Super-Resolution”, In: ECCV (2018) are called super-resolution GAN (SRGAN). The SRGAN achieves good performance.

Japanese Unexamined Patent Application Publication No. 2020-36773 discloses an image processing apparatus including a controller. The controller performs a thinning process for decreasing the number of pixels on a medical image to generate a thinned image. The controller inputs the thinned image to a neural network (hereinafter, abbreviated as “NN”) and extracts, using the thinned image as an input image and using the NN via a deep learning processor, a signal component of a predetermined structure in the medical image. The controller performs super-resolution processing on an output image output from the NN to generate a structure image that has the same number of pixels as the original medical image and that represents the signal component (including a high-frequency component) of the structure in the original medical image.

### SUMMARY

One conceivable method of removing or reducing dispensable information contained in an image is a method of reducing the resolution of an image and then recovering the resolution corresponding to the resolution of the original image through super-resolution. Components of dispensable information in an image are removed or reduced through the reduction in resolution, and the dispensable information is not sufficiently restored through super-resolution. Thus, the dispensable information is expectedly removed or reduced.

However, the larger the degree of resolution reduction is, the more the resulting image deteriorates. Conversely, if the degree of resolution reduction is too small, components of the dispensable information are not to be removed or reduced.

Aspects of non-limiting embodiments of the present disclosure relate to removing or reducing components of dispensable information in an image through resolution reduction and to reducing a deterioration of an image that results from a super-resolution process compared with a method in which the degree of resolution reduction is constant.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to perform a resolution reduction process on a target image to generate a low-resolution image, the resolution reduction process being a process in which a degree of resolution reduction changes depending on a size of the target image or a size of dispensable information contained in the target image; and perform a generation process of generating, based on the low-resolution image, a super-resolution image having a predetermined resolution corresponding to a resolution of the target image.

### BRIEF DESCRIPTION OF THE DRAWINGS

An exemplary embodiment of the present disclosure will be described in detail based on the following figures, wherein:

FIG. 1 illustrates an example of a functional configuration of an information processing apparatus;

FIG. 2 illustrates another example of the functional configuration of the information processing apparatus;

FIG. 3 illustrates an example of a configuration of a GAN-based system for training the information processing apparatus;

FIG. 4 illustrates an example of a mechanism of super-resolution used when the scale of down-sampling differs between regions;

FIG. 5 illustrates an example of the information processing apparatus in which a result of training performed by the system illustrated in FIG. 3 is implemented;

FIG. 6 illustrates another example of the configuration of the GAN-based system for training the information processing apparatus;

FIG. 7 illustrates an example of a mask;

FIG. 8 illustrates still another example of the configuration of the GAN-based system for training the information processing apparatus;

FIG. 9 illustrates still another example of the functional configuration of the information processing apparatus; and

FIG. 10 illustrates a hardware configuration of a computer.

### DETAILED DESCRIPTION

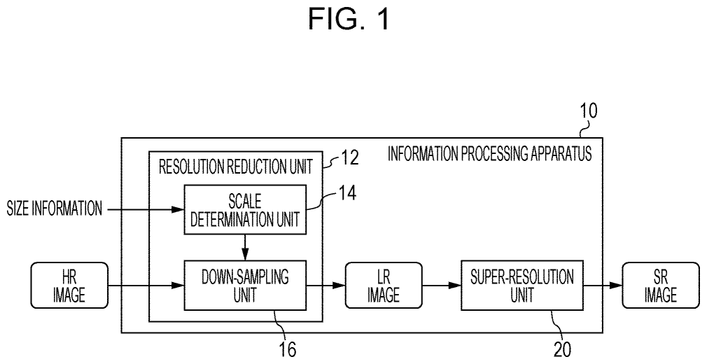

An example of an information processing apparatus 10 that removes or reduces dispensable information in an image will be described with reference to FIG. 1. The information processing apparatus 10 is an apparatus that processes an input image to generate an output image from which dispensable information in the input image has been removed or reduced. In drawings, an input image is referred to as an “HR image”, and an output image is referred to as an “SR image”. An HR image refers to an image having a high resolution. The term “high resolution” used herein indicates that the resolution is higher than the resolution of a low-resolution (LR) image that is temporarily generated from the HR image by the information processing apparatus 10. An SR image refers to a super-resolution image. An SR image is an image obtained by performing a super-resolution process on the LR image and has a higher resolution than the LR image. In a typical example, an SR image and an HR image have the same resolution; however, this is not mandatory. The resolution of the SR image may be lower than or higher than that of the HR image.

The dispensable information is information that is contained in an image in a recognizable form but is desirably removed from the image from the usage or the like of the image. For example, a finger of an image-capturing person, a face of a passerby, a fingerprint of a subject, or a background scenery on eyes of the subject which is depicted in an image is an example of the dispensable information.

The information processing apparatus 10 illustrated in FIG. 1 includes a resolution reduction unit 12 and a super-resolution unit 20. The resolution reduction unit 12 performs a resolution reduction process on an HR image, that is, a process of converting an HR image into an LR image having a lower resolution than the HR image. The resolution reduction unit 12 includes a scale determination unit 14 and a down-sampling unit 16.

The down-sampling unit 16 performs image down-sampling on an HR image to generate an LR image. Any image down-sampling methods including existing methods and methods to be developed in future may be used. Down-sampling may be, for example, processing of simply thinning pixels or processing of dividing an image into multiple blocks and generating a low-resolution image having representative values (for example, average pixel values) of the respective blocks.

The scale determination unit 14 determines the scale of down-sampling performed by the down-sampling unit 16, that is, a degree of resolution reduction. The scale is determined based on size information.

In one example, the size information is information indicating the size of an HR image or an SR image. In another example, the size information is information indicating the size of dispensable information in an HR image. In another conceivable example, both the information indicating the size of an HR image or an SR image and the information indicating the size of dispensable information are input to the scale determination unit 14 as the size information.

The size information may be information indicating a physical length or a size equivalent to the physical length, or information indicating the size represented in the number of pixels. The physical length indicated by the size represented in the number of pixels changes depending on the pixel size of a display device that displays an image. Specific examples of the information indicating a size equivalent to the physical length include information indicating a size of a medium that bears an SR image. The term “medium” refers to a screen of a display device that displays the image, a sheet on which the image is to be printed, and so on. The size of the screen is not limited to a size represented by a numerical value in inches and may be a size indicating the class based on the size of the display device, for example, the smartphone size, the tablet size, or the like.

The size information input to the scale determination unit 14 may be information indicating a degree of deviation between the size of an HR image and the size of the dispensable information. This information may indicate, for example, a ratio between the size of an HR image and the size of the dispensable information or a difference between the size of the HR image and the size of the dispensable information.

The size information may be input by a user or may be determined by the information processing apparatus 10. For example, the user may input a numerical value of the size or other information for identifying the size (for example, information indicating the class of the size of the screen such as the smartphone size or the tablet size, or information indicating the class of the size of a sheet). Alternatively, the information processing apparatus 10 may acquire information on the size of the screen of a terminal including the information processing apparatus 10 from the operating system of the terminal and may use the acquired information as the size information. Alternatively, the information processing apparatus 10 may determine, from attribute information of an application that executes an SR image display process, the size of the screen of a terminal on which the application is executed, and may use the determined size of the screen as the size information.

For example, the scale determination unit 14 may determine the scale, based on a degree of deviation between the size of an HR image and the size of the dispensable information in the HR image, for example, a difference or ratio between these sizes. In a more specific example, as the deviation of the size of the dispensable information from the size of the HR image decreases (for example, a ratio of the former to the latter approaches 1), the scale determination unit 14 increases the scale of down-sampling, that is, the degree of resolution reduction. For example, when the ratio of the size of the dispensable information to the size of the HR image is 1/20, the scale determination unit 14 determines the scale of down-sampling to be 2 (so that 2×2 pixels are converted into 1 pixel). When the ratio of the size of the dispensable information to the size of the HR image is 1/10, the scale determination unit 14 determines the scale of down-sampling to be 4 (so that 4×4 pixels are converted into 1 pixel). To determine the scale, for example, it is sufficient to prepare a function or table for determining the scale of down-sampling from the degree of deviation between the size of the HR image and the size of the dispensable information. As the size of the dispensable information becomes closer to the size of the HR image, the scale of down-sampling is set to a larger value. This consequently makes a probability of a visually recognizable level of components of the dispensable information remaining in an SR image output by the information processing apparatus 10 lower than in the case where the scale is set constant.

Alternatively, as the size of the HR image increases, the scale determination unit 14 may increase the scale of down-sampling. A larger HR image is more likely to contain a large amount of dispensable information. To make such a large amount of dispensable information unperceivable, the larger the amount of dispensable information is, the more greatly down-sampling is to be performed.

Alternatively, as the size of the dispensable information in the HR image increases, the scale determination unit 14 may increase the scale of down-sampling.

The down-sampling unit 16 performs down-sampling on the HR image in accordance with the scale determined by the scale determination unit 14. For example, when the scale is determined to be 2, the down-sampling unit 16 sets, as a block, each group of four (=2×2) pixels adjacent to each other in the HR image and performs down-sampling for converting each block into one pixel. Any down-sampling method may be used. For example, down-sampling may be simple thinning (that is, processing of outputting a value of a single particular pixel in each block and discarding values of the other pixels in the block) or may be processing of outputting an average of pixel values of the pixels in each block as a value of a corresponding output pixel.

Through such processing, the down-sampling unit 16 converts the HR image into an LR image having a lower resolution than the HR image.

The super-resolution unit 20 performs a super-resolution process on the LR image to generate an SR image. Any super-resolution method may be used. For example, an image-processing-based method such as pixel interpolation may be used, or an NN-based method such as SRGAN may be used. Components of the dispensable information are greatly reduced in the LR image. Thus, even if the super-resolution process is performed on the LR image, the original dispensable information is not restored. In this manner, an SR image from which the dispensable information has been removed or reduced is obtained.

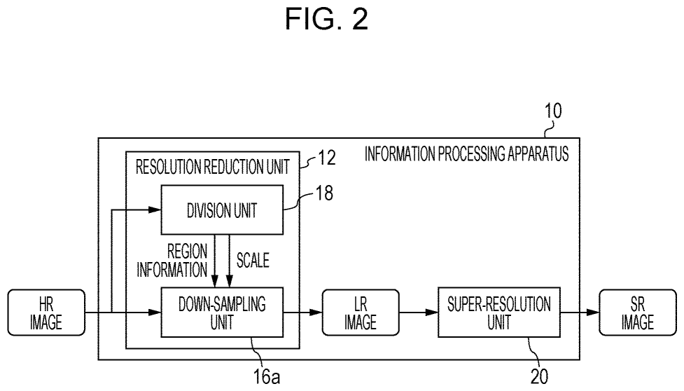

Another example of the information processing apparatus 10 will be described next with reference to FIG. 2. The information processing apparatus 10 illustrated in FIG. 2 includes a division unit 18 in place of the scale determination unit 14 as a component of the resolution reduction unit 12, which is different from the information processing apparatus 10 illustrated in FIG. 1. The information processing apparatus 10 illustrated in FIG. 2 also includes a down-sampling unit 16a. The down-sampling unit 16a has a function which the down-sampling unit 16 included in the information processing apparatus 10 illustrated in FIG. 1 lacks.

The division unit 18 divides an input HR image into multiple regions. For example, an image segmentation technique may be used in this division.

For example, the use of semantic segmentation which is one of image segmentation techniques enables an HR image to be divided into regions corresponding to respective classes. Classes in semantic segmentation are equivalent to kinds of objects in an image. Semantic segmentation is a deep-learning-based technique. In an example of using the semantic segmentation technique, the division unit 18 has been trained to identify, in an input image, regions each of which corresponds to a corresponding class of one or more predetermined classes. In this example, the division unit 18 identifies, in an image, regions each of which corresponds to a corresponding class of the classes which the division unit 18 has learned. The division unit 18 may also identify a region that belongs to none of the classes which the division unit 18 has learned. For example, the division unit 18 that has been trained to identify a region corresponding to a class “human face” divides an input HR image into a region of the “human face” and the other region (=“background”). For example, the division unit 18 that has learned two classes of “eye” and “human face” divides an input HR image into three kinds of regions, that is, a region of “eye”, a region of “human face” excluding the eyes, and the other region.

The use of semantic segmentation is merely an example. The division unit 18 may be based on an image segmentation technique other than semantic segmentation, such as instance segmentation. Alternatively, the division unit 18 may be based on a technique other than the image segmentation techniques.

The division unit 18 also determines, for each of the multiple regions resulting from division of an HR image, the size of the region and determines a scale of down-sampling to be applied to the region in accordance with the determined size.

As the size of a region, for example, the number of pixels included in the region or a size of a bounding box of the region may be used, which is merely an example. A bounding box of a region is a rectangle that has sides parallel to the vertical and horizontal sides of an HR image and that circumscribes the region. For example, a length of a diagonal line of the bounding box or one (for example, a shorter one) of a width and a height of the bounding box may be used as the size of the bounding box.

For example, as the size of the region increases, the division unit 18 increases the scale of down-sampling to be applied to a region. A larger region is more likely to contain a large amount of dispensable information. Thus, the scale of down-sampling is increased so that such a large amount of dispensable information is successfully removed or reduced.

In another example, there may be cases where the size of the dispensable information possibly contained in a region or a ratio of the size of the dispensable information to the size of the region is given in advance. For example, in the case of a region corresponding to a class “fingertip”, information of fingerprint on the fingertip is dispensable information that is desirably removed from an SR image serving as an output. In this case, a ratio between a width of a line constituting the fingerprint and the size of the fingertip is expectable to some extent. In such a case, as the deviation between the size of the region and the size of the dispensable information decreases (for example, the ratio between the aforementioned sizes approaches 1), the division unit 18 may increase the scale of down-sampling.

In still another example, the division unit 18 may determine the scale of down-sampling, based on a class of a region (that is, a kind of an object corresponding to the region). For example, if the class of a region is “fingertip”, the scale of down-sampling for making the fingerprint, which is the dispensable information, unperceivable is approximately determined. In addition, for example, if the class of a region is a class having a low probability of containing the dispensable information, the scale of down-sampling may be determined to be a small value. When the scale of down-sampling is small, a deterioration of the image quality (for example, in a high-frequency component of the image) caused by down-sampling is small.

Alternatively, the division unit 18 may determine the scale of down-sampling, based on both the class of a region and the size of the region. For example, a table or the like may be used in which, for each set of a class and a region, a value of the scale corresponding to the set is registered. If regions belong to the same class, the larger the size of the region is, the larger the scale of down-sampling is set to be. For example, even if regions belong to the same class “fingertip”, the larger the size of the region is, the larger the pattern of the fingerprint in the region is. Thus, the degree of resolution reduction is to be increased in order to make the fingerprint unperceivable.

The division unit 18 supplies, for each of the regions resulting from division, region information for identifying the region (for example, information indicating which class the region corresponds to) and information on the scale of down-sampling to be applied to the region to the down-sampling unit 16a.

Based on the region information and the information on the scale obtained from the division unit 18, the down-sampling unit 16a performs down-sampling on the corresponding region of the HR image in accordance with the scale corresponding to the region. For example, suppose that an HR image is divided into a region of the “human face” and a region of the “background” and that the scale of down-sampling for the former and the scale of down-sampling for the latter are determined to be 2 and 4, respectively. In this case, the down-sampling unit 16a performs down-sampling on the region of the “human face” to convert 2×2 pixels into 1 pixel and performs down-sampling on the region of the “background” to convert 4×4 pixels into 1 pixel. The down-sampling unit 16a supplies, for each of the regions, an LR image which is a down-sampling result of the region and information on the scale of down-sampling applied to the region to the super-resolution unit 20.

The super-resolution unit 20 performs, for each of the regions, a super-resolution process on the LR image of the region in accordance with the scale of down-sampling applied to the region to generate an SR image having a predetermined resolution. For example, suppose that an HR image is divided into a region of the “human face” and a region of the “background” and that the scale of down-sampling for the former is 2 and the scale of down-sampling for the latter is 4. In such a case, the super-resolution unit 20 performs the super-resolution process to double the former region (that is, increase the number of pixels 4 times) and the super-resolution process to quadruple the latter region (that is, increase the number of pixels 16 times). Consequently, an SR image having the same resolution as the original HR image is obtained.

As described above, the information processing apparatus 10 illustrated in FIG. 2 controls, for each of the regions, the scale of down-sampling to be a value suitable for the region. Consequently, the dispensable information in each region is removed or sufficiently reduced and an excessive deterioration of the image quality is avoided.

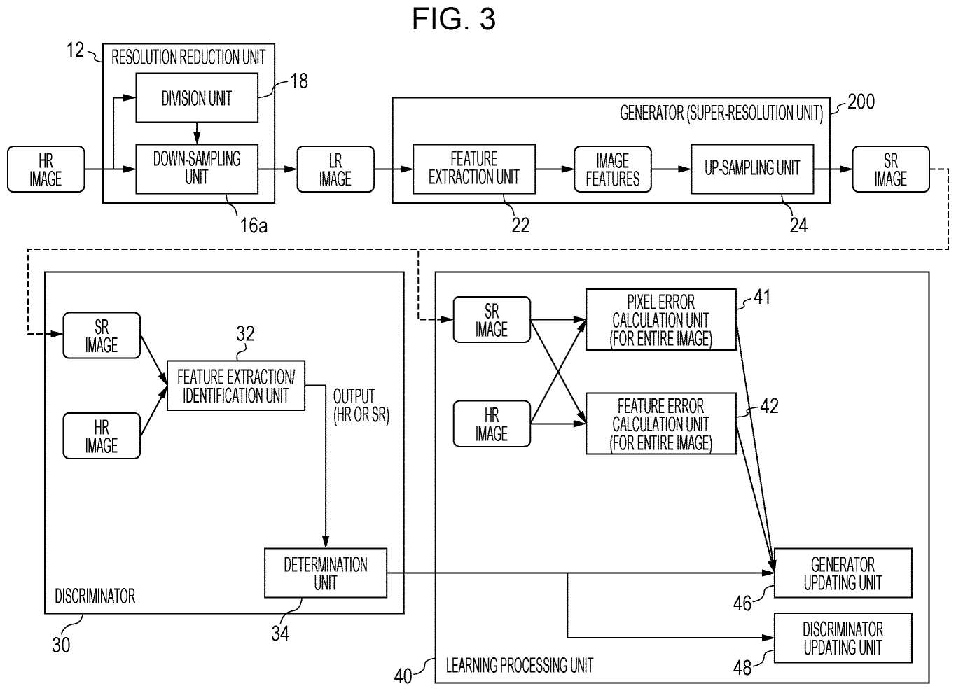

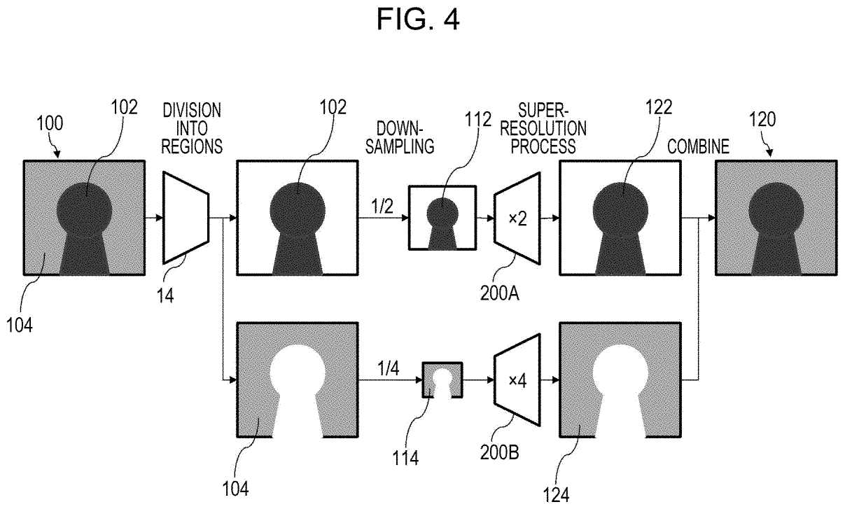

With reference to FIGS. 3 and 4, description will be given next of an example of a configuration of a system used when the super-resolution unit 20 is constructed using the GAN-based technique. This example is an example in which the configuration of an apparatus that uses the method of dividing an input image into regions, which is illustrated in FIG. 2, is implemented based on the GAN. Although description is omitted because duplicate description increases, the configuration of an apparatus that uses the method of uniformly determining the scale of down-sampling to be applied to the entire image in accordance with the size information, which is illustrated in FIG. 1, may also be implemented based on the GAN similarly.

FIG. 3 illustrates an example of a configuration of this system in training. The system includes the resolution reduction unit 12, a generator 200, a discriminator 30, and a learning processing unit 40. Under the control of the learning processing unit 40, the generator 200 and the discriminator 30 perform adversarial learning in accordance with the mechanism of the GAN. Consequently, the generator 200 that generates an SR image that is difficult to visually differentiate from an HR image is obtained. The generator 200 that has been sufficiently trained functions as the super-resolution unit 20.

The resolution reduction unit 12 has a configuration that is substantially the same as that illustrated in FIG. 2. The resolution reduction unit 12 divides an input HR image into multiple regions, performs down-sampling on each of the regions at a scale corresponding to the region, and outputs a resultant LR image.

The generator 200 includes a feature extraction unit 22 and an up-sampling unit 24. The feature extraction unit 22 extracts, from the input LR image, data representing features of the LR image, that is, image features. The up-sampling unit 24 generates, from the image features, an image having a predetermined resolution, that is, an SR image. The feature extraction unit 22 and the up-sampling unit 24 are configured as an NN-based system including a convolutional NN or the like, similarly to a generator of an existing SRGAN, for example.

The SR image generated by the generator 200 or the HR image which is the origin of the SR image is input to the discriminator 30. The discriminator 30 identifies whether the input image is real (i.e., the HR image) or counterfeit (i.e., the SR image). The generator 200 is trained to generate, from an LR image, an SR image which is difficult to differentiate from an original HR image, whereas the discriminator 30 is trained to differentiate between the HR image and the SR image. In this manner, the generator 200 and the discriminator 30 are trained in an adversarial manner, that is, a competitive manner. This consequently increases both the performance of the generator 200 and the performance of the discriminator 30.

In the discriminator 30, a feature extraction/identification unit 32 extracts image features from an input image (i.e., an HR image or an SR image) and identifies, based on the image features, whether the input image is an HR image or an SR image. The output of the feature extraction/identification unit 32 is, for example, binary data indicating the identification result. In another example, the feature extraction/identification unit 32 may determine, as the identification result, a probability of the input image being the true image (that is, an HR image). In this case, the identification result output by the feature extraction/identification unit 32 is a real value from 0 to 1. If it is certain that the input image is the HR image, the value of the identification result is equal to 1. Conversely, if it is certain that the input image is the SR image, the value of the identification result is equal to 0. Note that the image features extracted from the input image by the feature extraction/identification unit 32 are image features used for differentiating between an HR image and an SR image. Therefore, the image features do not necessarily coincide with image features extracted by the feature extraction unit 22 of the generator 200 for performing a super-resolution process. The feature extraction/identification unit 32 is configured as an NN-based system including a convolutional NN or the like, similarly to a discriminator of an existing SRGAN, for example.

In the discriminator 30, a determination unit 34 determines whether the identification result output by the feature extraction/identification unit 32 is correct. Specifically, the determination unit 34 receives, from an image input controller (not illustrated) of the discriminator 30, a signal indicating which of the HR image and the SR image has been input to the feature extraction/identification unit 32. The determination unit 34 compares the signal with the identification result output by the feature extraction/identification unit 32 to determine whether the identification result is correct. Alternatively, in the example in which the feature extraction/identification unit 32 outputs, as the identification result, the probability of the input image being an HR image, the determination unit 34 compares the identification result with the signal indicating which of the HR image and the SR image has been actually input by the image input controller. Based on this comparison, the determination unit 34 determines a score indicating a degree of the identification result being correct. Suppose that the image that has been actually input is an HR image, for example. In this case, the determination unit 34 determines that the score is 100 points (=highest score) when the identification result is equal to 1.0 (that is, the probability of the input image being the HR image is highest), that the score is 70 points when the identification result is equal to 0.7, and that the score is 0 points (=lowest score) when the identification result is equal to 0.0. In addition, suppose that the image that has been actually input is an SR image, for example. In this case, the determination unit 34 determines that the score is 0 points when the identification result is equal to 1.0, that the score is 30 points when the identification result is equal to 0.7, and that the score is 100 points when the identification result is equal to 0.0. The determination unit 34 outputs the score thus determined as a determination result. The determination result is provided to a generator updating unit 46 and a discriminator updating unit 48 of the learning processing unit 40.

The learning processing unit 40 performs a process of training the NNs in the generator 200 and the discriminator 30. An HR image and an SR image generated by the generator 200 from an LR image that is a reduced-resolution image of the HR image are input to the learning processing unit 40.

The learning processing unit 40 includes a pixel error calculation unit 41, a feature error calculation unit 42, the generator updating unit 46, and the discriminator updating unit 48.

The pixel error calculation unit 41 calculates, as a loss in the SR image with respect to the HR image, an error between pixels in the SR image and respective pixels in the HR image. As the error between the pixels, for example, a mean square error of the pixels of the SR image and the respective pixels of the HR image may be used. Alternatively, an error of another kind may be used. When the SR image and the HR image have different resolutions, the resolutions of the SR image and the HR image are equalized by pixel interpolation or another method. Then, the SR image and the HR image may be input to the pixel error calculation unit 41.

The feature error calculation unit 42 extracts image features from the SR image and image features from the HR image, and calculates an error (hereinafter, referred to as a feature error) between the image features of the SR image and the image features of the HR image. This error may be determined using a method such as a mean square error. Note that the image features extracted by the feature error calculation unit 42 are not necessarily the same as the image features extracted by the feature extraction unit 22 of the generator 200 nor the image features extracted by the feature extraction/identification unit 32 of the discriminator 30.

Based on the errors input from the pixel error calculation unit 41 and the feature error calculation unit 42 and the determination result input from the determination unit 34, the generator updating unit 46 trains the NN of the generator 200, that is, the feature extraction unit 22 and the up-sampling unit 24. Specifically, the generator updating unit 46 updates coupling coefficients between neurons in the NN of the generator 200 in accordance with the inputs to decrease the pixel error and the feature error. In this manner, the generator updating unit 46 trains the NN.

Based on the determination result input from the determination unit 34, the discriminator updating unit 48 trains the NN of the discriminator 30, that is, the feature extraction/identification unit 32.

In the illustrated example, the learning processing unit 40 calculates the errors between the HR image and the SR image as a loss, and trains, based on the errors, the generator 200 and the discriminator 30. Alternatively, the learning processing unit 40 may use another loss function other than the errors.

Many HR images are sequentially input to the system described above with reference to FIG. 3 to train the generator 200 and the discriminator 30. The generator 200 obtained as a result of this training has a capability of generating an SR image which is difficult to visually differentiate from an HR image and from which dispensable information in the HR image has been removed or sufficiently reduced.

Note that in the system illustrated in FIG. 3, an HR image is divided into multiple regions, and down-sampling is performed on the individual regions at individual scales. Thus, the resolution of the LR image may differ from region to region. The use of the plural generators 200 is one of methods for coping with this state.

In this method, the generators 200 are prepared for respective resolutions of the LR images (in other words, for respective scales of down-sampling), and the LR images of the respective regions are input to the corresponding generators 200 associated with the respective resolutions. Each of the generators 200 associated with the respective resolutions performs a super-resolution process to increase the resolution of the input LR image to the resolution of the SR image. The results of the super-resolution process performed on the regions are combined together to create the SR image.

FIG. 4 illustrates an example of a flow of the processes performed by the resolution reduction unit 12 and the generator 200 in response to input of an HR image 100 constituted by regions of two classes that are a person's upper part 102 and a background 104. In this example, the division unit 18 divides the HR image 100 into a region of the person's upper part 102 and a region of the background 104 using a technique such as semantic segmentation. It is assumed in this example that the down-sampling unit 16a performs down-sampling on the region of the person's upper part 102 at a scale of 2 (that is, reduction by ½) and performs down-sampling on the region of the background 104 at a scale of 4. Consequently, an image 112 of the person's upper part having a half the resolution of the HR image and an image 114 of the background having a quarter the resolution of the HR image are obtained. The image 112 of the person's upper part is input to a generator 200A for double enlargement. The generator 200A performs the super-resolution process on the image to generate an image 122 of the person's upper part having the resolution of the SR image. The image 114 of the background is input to a generator 200B for quadruple enlargement. The generator 200B performs the super-resolution process on the image to generate an image 124 of the background having the resolution of the SR image. The image 122 and the image 124 are combined together. Consequently, an SR image 120 corresponding to the HR image 100 is created.

In another example, the generators 200 may be prepared for respective combinations of a resolution of an LR image of a region and a class of the region, and each of the LR images of the regions may be input to the corresponding generator 200 corresponding to the combination of the resolution of the LR image and the class of the region among the generators 200.

That is, in response to an HR image being input to the system for training illustrated in FIG. 3, the resolution reduction unit 12 generates LR images of respective regions from the HR image. Each of the LR images of the respective regions is input to the generator 200 corresponding to the resolution of the region or the combination of the resolution and the class among the plural generators 200. Each of the generators 200 performs the super-resolution process on the input LR image(s) of the region(s). Images resulting from the super-resolution process performed on these regions are combined together. Consequently, an SR image corresponding to the original HR image is created. The discriminator 30 attempts to differentiate this SR image from the HR image. Based on the SR image, the original HR image, and information on the identification result obtained by the discriminator 30, the learning processing unit 40 trains the generators 200 and the discriminator 30.

Instead of using the plural generators 200, a configuration may be adopted in which the LR images of the respective regions are subjected to resolution conversion to have a resolution in common (that is, the input resolution for the generator 200) and are processed by the single generator 200.

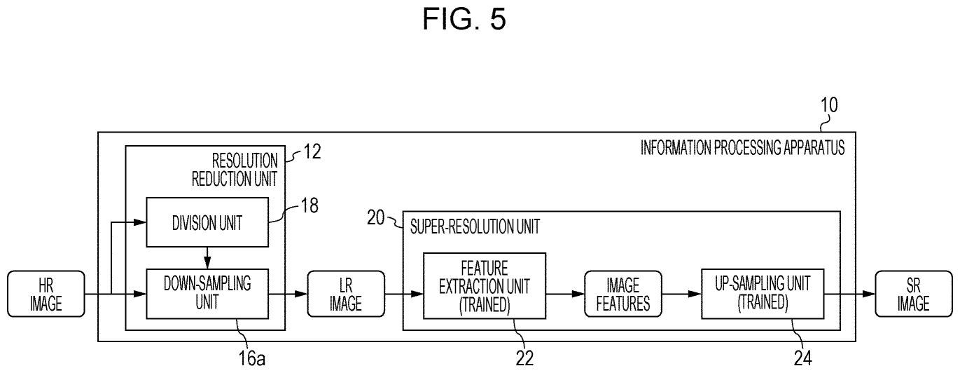

FIG. 5 illustrates a configuration of the information processing apparatus 10 including, as the super-resolution unit 20, the generator 200 that has been trained by the system illustrated in FIG. 3.

The information processing apparatus 10 illustrated in FIG. 5 includes the generator 200 that has been trained by the system illustrated in FIG. 3, as the super-resolution unit 20 of the information processing apparatus 10 illustrated in FIG. 2. That is, the super-resolution unit 20 of the information processing apparatus 10 illustrated in FIG. 5 includes the feature extraction unit 22 and the up-sampling unit 24 that have been trained. In implementation, for example, parameters (for example, coupling coefficients between neurons) of the feature extraction unit 22 and the up-sampling unit 24 determined through training performed in the system illustrated in FIG. 3 may be copied in the NN of the information processing apparatus 10 to configure the super-resolution unit 20.

In the information processing apparatus 10 illustrated in FIG. 5, the division unit 18 divides an input HR image into multiple regions, and outputs, to the down-sampling unit 16a, region information and scale information regarding each of the regions resulting from the division. The down-sampling unit 16a identifies individual regions in the HR image in accordance with the region information, and performs down-sampling on an image of each of the identified regions at a scale corresponding to the region. An LR image of each region output from the down-sampling unit 16a has a resolution corresponding to the scale of the region. This LR image is input to the super-resolution unit 20. The feature extraction unit 22 and the up-sampling unit 24 of the super-resolution unit 20 have already been trained using many HR images as training data. The feature extraction unit 22 determines image features of the input LR image. Based on the image features, the up-sampling unit 24 generates an SR image having a predetermined resolution.

In the example illustrated in FIG. 5, the information processing apparatus 10 includes a single super-resolution unit 20. Alternatively, the information processing apparatus 10 may include the super-resolution unit 20 for each scale of down-sampling, that is, for each resolution of the LR image. The super-resolution units 20 for respective resolutions have been trained in the above-described manner, for example. The feature extraction unit 22 of the super-resolution unit 20 corresponding to a certain resolution has an input layer that includes a number of neurons corresponding to the resolution, and converts the input LR image of the region having the resolution into image features represented by, for example, a combination of output values of a predetermined number of neurons in an output layer. The up-sampling unit 24 converts the image features into an image having the resolution of the SR image. The SR images of the regions generated from the respective LR images of the regions having the resolutions corresponding to the respective super-resolution units 20 are combined into a single image by a combination unit (not illustrated). Consequently, a single complete SR image is generated.

Alternatively, the information processing apparatus 10 may include the super-resolution unit 20 for each combination of the resolution and the class of the region.

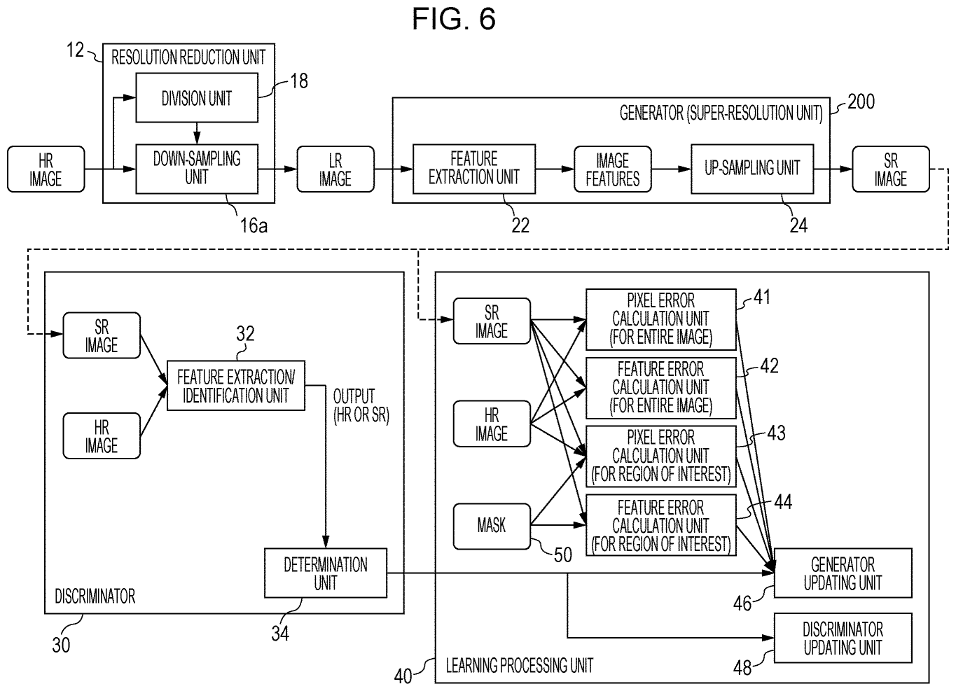

An improved example of the system for training illustrated in FIG. 3 will be described next with reference to FIG. 6.

An image often includes both a region of an object to be focused on (hereinafter, referred to as a region of interest) and the other region, for example, as in the case where a photograph expectedly includes a subject and the subject and the rest (background, for example) are distinguished from each other. The region of interest in an image is often a necessary portion of the image. Dispensable information is often contained in a region other than the region of interest.

In the system illustrated in FIG. 3, the generator 200 is trained to make an SR image from which the dispensable information has been removed or reduced more difficult to differentiate from an HR image containing the dispensable information. Thus, the image quality of the region not containing the dispensable information in the SR image, particularly, the image quality of the region of interest may be adversely influenced. The system illustrated in FIG. 6 attempts to reduce such an adverse influence on the image quality of the region of interest.

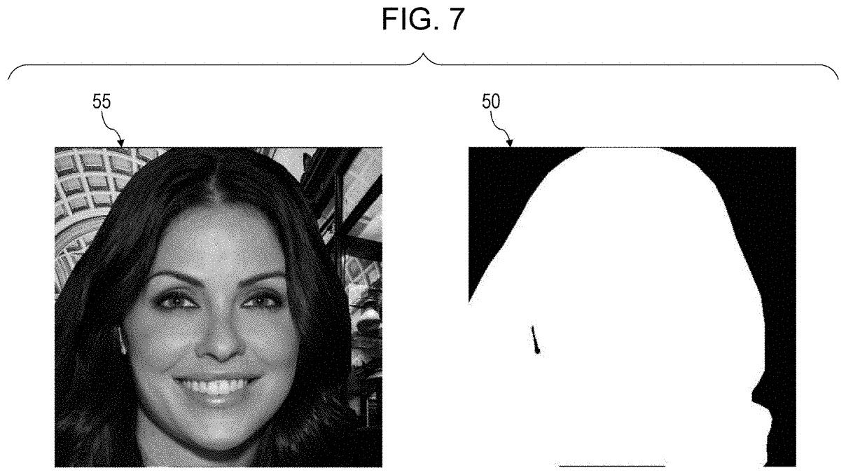

The system illustrated in FIG. 6 uses a mask 50 in the learning processing unit 40. The mask 50 is used for extracting the region of interest alone from an HR image and an SR image. For example, in the case where a person's face is an object to be focused on (in other words, when the target for which the image quality is to be maintained as much as possible is a person's face), the mask 50 is used for an image 55 illustrated in FIG. 7 to extract a region of the person's face from the image 55 and mask the other region.

The learning processing unit 40 includes, in addition to the pixel error calculation unit 41 and the feature error calculation unit 42 that are used for the entire image, a pixel error calculation unit 43 and a feature error calculation unit 44 that are used merely for the region of interest extracted by the mask 50. The pixel error calculation unit 43 applies the mask 50 to the input HR image and SR image to extract groups of pixels of the regions of interest in the respective images. The pixel error calculation unit 43 then calculates an error (for example, a mean square error) between the pixels in the region of interest of the HR image and the pixels in the region of interest of the SR image. Likewise, the feature error calculation unit 44 applies the mask 50 to extract groups of pixels of the regions of interest in the HR image and the SR image, determines image features of the regions of interest of the respective images, and calculates an error between the image features.

The pixel error and the feature error respectively determined by the pixel error calculation unit 41 and the feature error calculation unit 42 for the entire image and the pixel error and the feature error respectively determined by the pixel error calculation unit 43 and the feature error calculation unit 44 for the region of interest are input to the generator updating unit 46. The generator updating unit 46 updates coupling coefficients between neurons in the NN of the generator 200 to decrease the pixel error and the feature error of the entire image and the pixel error and the feature error of the region of interest.

As described above, in the example illustrated in FIG. 6, the generator 200 is trained to decrease the pixel error and the feature error of the region of interest. Thus, an adverse influence of removal or reduction of the dispensable information on the image quality of the region of interest in the SR image is reduced.

In the example illustrated in FIG. 6, it is conceivable that the pixel error calculation unit 41 and the feature error calculation unit 42 that are used for the entire image are removed from the learning processing unit 40. However, if the pixel error calculation unit 41 and the feature error calculation unit 42 that are used for the entire image are removed, the image quality deteriorates at the periphery and outer portion of the region of interest. Thus, the configuration including the pixel error calculation unit 41 and the feature error calculation unit 42 as in the example illustrated in FIG. 6 can achieve a good image quality as a whole.

The generator 200 trained in the system illustrated in FIG. 6 is used as the super-resolution unit 20 of the information processing apparatus 10 illustrated in FIG. 5.

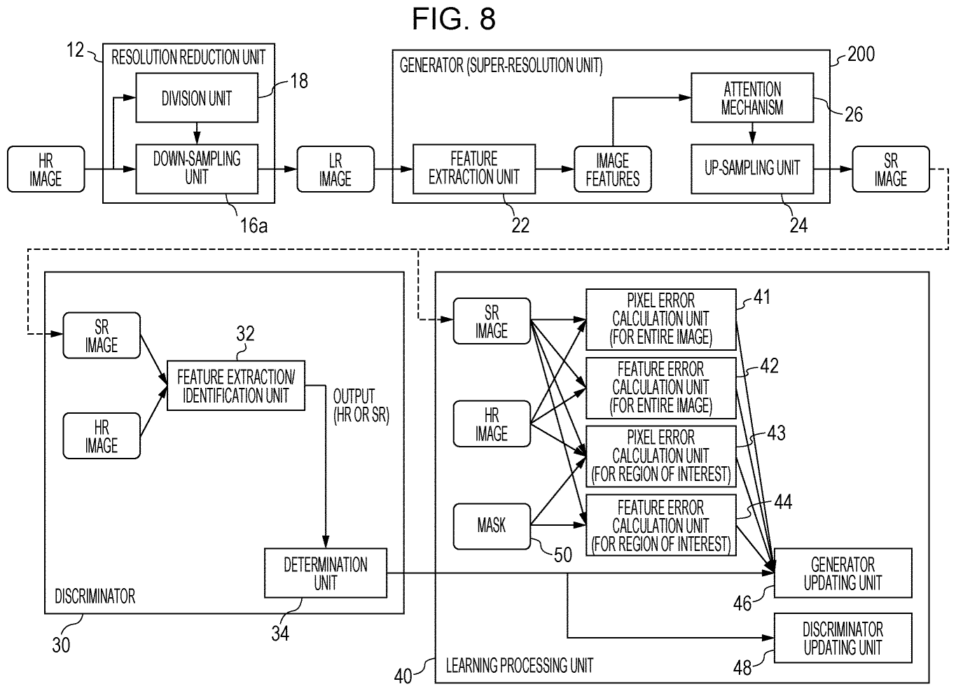

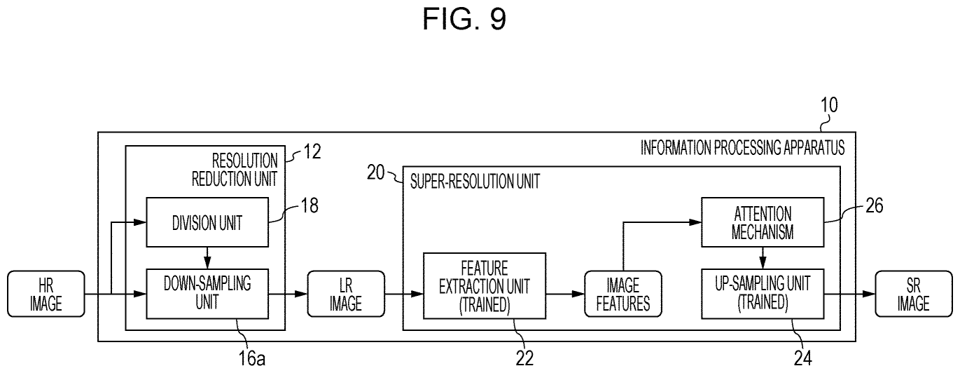

An example of including an attention mechanism 26 will be described next with reference to FIGS. 8 and 9.

FIG. 8 illustrates an example of a system for training in this example. The generator 200 of this system includes the attention mechanism 26. The attention mechanism 26 is a mechanism that learns elements to which an attention to be paid among input elements. For example, an existing mechanism such as a self-attention mechanism presented by Han Zhang et al., “Self-Attention Generative Adversarial Networks” (https://arxiv.org/abs/1805.08318) may be used as the attention mechanism 26.

The attention mechanism 26 receives the image features output by the feature extraction unit 22, and generates weighted outputs of image features so that elements having a strong relationship (that is, elements to which an attention to be paid more) among elements (output values of the neurons of the feature extraction unit 22) of the image features are reflected strongly. The up-sampling unit 24 performs the super-resolution process on the outputs of the attention mechanism 26 to generate an SR image.

The generator updating unit 46 of the learning processing unit 40 also updates weight coefficients of the attention mechanism 26 so that the attention mechanism 26 calculates more appropriate attention weights.

In response to the completion of training of the generator 200 and the discriminator 30, the information processing apparatus 10 (see FIG. 9) including the generator 200 as the super-resolution unit 20 can be configured. The information processing apparatus 10 illustrated in FIG. 9 includes the attention mechanism 26 in the super-resolution unit 20, which is different from the information processing apparatus 10 illustrated in FIG. 5. The information processing apparatus 10 illustrated in FIG. 9 generates a higher-quality SR image than the information processing apparatus 10 including the super-resolution NN not including the attention mechanism 26.

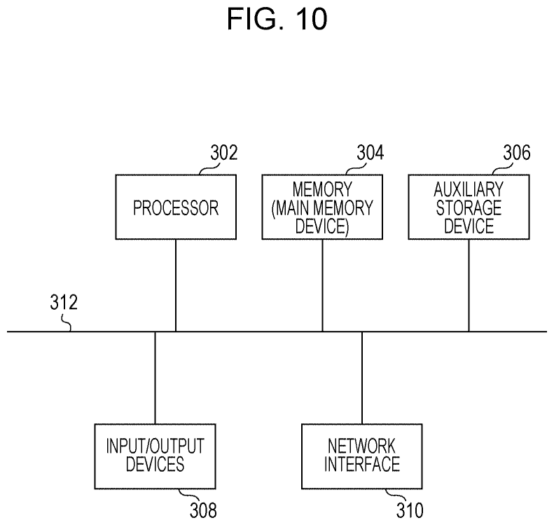

The information processing apparatus 10 illustrated in FIGS. 1, 2, 5, and 9 and the system illustrated in FIGS. 3, 6, and 8 are build, for example, using a general-purpose computer. In such a case, the computer has a circuit configuration below as illustrated in FIG. 10, for example. The computer includes, as hardware, a processor 302; a memory (main memory device) 304 such as a random access memory (RAM); an auxiliary storage device 306 that is a nonvolatile storage device such as a flash memory, a solid state drive (SSD), or a hard disk drive (HDD); various input/output devices 308; and a network interface 310 that controls connection to a network such as a local area network. The processor 302, the memory 304, the auxiliary storage device 306, the input/output devices 308, and the network interface 310 are connected to each other by a data channel such as a bus 312, for example. In the example illustrated in FIG. 10, all the components such as the processor 302, the memory 304, the auxiliary storage device 306, the input/output devices 308, and the network interface 310 are equally connected to the same bus 312. However, this configuration is merely an example. Instead of this configuration, a hierarchical configuration may be adopted in which some of those components (for example, a group of components including the processor 302) are integrated on a single chip as in a System-on-a-Chip (SoC), for example, and the rest of the components are connected to an external bus to which the chip is connected.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In addition, some or all of the components of the information processing apparatus 10 illustrated in FIGS. 1, 2, 5, and 9 and the system illustrated in FIGS. 3, 6, and 8 may be configured as hardware circuitry.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
perform a resolution reduction process on a target image to generate a low-resolution image, the resolution reduction process being a process in which a degree of resolution reduction changes depending on a size of the target image or a size of dispensable information contained in the target image, and
perform a generation process of generating, based on the low-resolution image, a super-resolution image having a predetermined resolution corresponding to a resolution of the target image.

2. The information processing apparatus according to claim 1, wherein in the resolution reduction process, as a deviation between the size of the target image and the size of the dispensable information decreases, the degree of resolution reduction is increased.

3. The information processing apparatus according to claim 2, wherein in the resolution reduction process, as the size of the target image increases, the degree of resolution reduction is increased.

4. The information processing apparatus according to claim 2, wherein in the resolution reduction process, as the size of the dispensable information increases, the degree of resolution reduction is increased.

5. The information processing apparatus according to claim 1,
wherein the processor is further configured to divide an input image into a plurality of regions,
wherein the resolution reduction process is performed on images of the plurality of regions resulting from the division to generate low-resolution images, each of the images of the plurality of regions serving as the target image, and
wherein the processor is configured to
generate, based on the low-resolution images corresponding to the respective target images, super-resolution images having the predetermined resolution, and
generate, from the generated super-resolution images, a super-resolution image corresponding to the input image.

6. The information processing apparatus according to claim 2,
wherein the processor is further configured to divide an input image into a plurality of regions,
wherein the resolution reduction process is performed on images of the plurality of regions resulting from the division to generate low-resolution images, each of the images of the plurality of regions serving as the target image, and
wherein the processor is configured to
generate, based on the low-resolution images corresponding to the respective target images, super-resolution images having the predetermined resolution, and
generate, from the generated super-resolution images, a super-resolution image corresponding to the input image.

7. The information processing apparatus according to claim 3,
wherein the processor is further configured to divide an input image into a plurality of regions,
wherein the resolution reduction process is performed on images of the plurality of regions resulting from the division to generate low-resolution images, each of the images of the plurality of regions serving as the target image, and
wherein the processor is configured to
generate, based on the low-resolution images corresponding to the respective target images, super-resolution images having the predetermined resolution, and
generate, from the generated super-resolution images, a super-resolution image corresponding to the input image.

8. The information processing apparatus according to claim 4,
wherein the processor is further configured to divide an input image into a plurality of regions,
wherein the resolution reduction process is performed on images of the plurality of regions resulting from the division to generate low-resolution images, each of the images of the plurality of regions serving as the target image, and
wherein the processor is configured to
generate, based on the low-resolution images corresponding to the respective target images, super-resolution images having the predetermined resolution, and
generate, from the generated super-resolution images, a super-resolution image corresponding to the input image.

9. The information processing apparatus according to claim 5, wherein in the resolution reduction process, as the size of a region among the plurality of regions increases, the degree of resolution reduction is increased.

10. The information processing apparatus according to claim 6, wherein in the resolution reduction process, as the size of a region among the plurality of regions increases, the degree of resolution reduction is increased.

11. The information processing apparatus according to claim 7, wherein in the resolution reduction process, as the size of a region among the plurality of regions increases, the degree of resolution reduction is increased.

12. The information processing apparatus according to claim 8, wherein in the resolution reduction process, as the size of a region among the plurality of regions increases, the degree of resolution reduction is increased.

13. The information processing apparatus according to claim 5,
wherein in the division, the input image is divided into the plurality of regions according to kinds of objects in the input image, and
wherein in the resolution reduction process, the resolution of each of the images of the plurality of regions is reduced at the degree of resolution reduction according to the kind of the object corresponding to the region.

14. The information processing apparatus according to claim 6,
wherein in the division, the input image is divided into the plurality of regions according to kinds of objects in the input image, and
wherein in the resolution reduction process, the resolution of each of the images of the plurality of regions is reduced at the degree of resolution reduction according to the kind of the object corresponding to the region.

15. The information processing apparatus according to claim 7,
wherein in the division, the input image is divided into the plurality of regions according to kinds of objects in the input image, and
wherein in the resolution reduction process, the resolution of each of the images of the plurality of regions is reduced at the degree of resolution reduction according to the kind of the object corresponding to the region.

16. The information processing apparatus according to claim 9,
wherein in the division, the input image is divided into the plurality of regions according to kinds of objects in the input image, and
wherein in the resolution reduction process, the resolution of each of the images of the plurality of regions is reduced at the degree of resolution reduction according to the kind of the object corresponding to the region.

17. The information processing apparatus according to claim 1,
wherein the generation process is performed using a generator included in a trained generative adversarial network including the generator and a discriminator, and
wherein in training of the generative adversarial network, the generator is trained to generate the super-resolution image having the predetermined resolution from the low-resolution image corresponding to the target image, and the discriminator is trained to differentiate between the target image and the super-resolution image having the predetermined resolution.

18. The information processing apparatus according to claim 17, wherein in the training of the generative adversarial network, a loss is calculated based on information on a region of an object of interest in the target image, and the generator is trained based on the calculated loss.

19. The information processing apparatus according to claim 1, wherein the generation process is performed with a mechanism including
a first neural network configured to extract an image feature from the low-resolution image,
an attention mechanism configured to process the image feature, and
a second neural network configured to generate the super-resolution image having the predetermined resolution from an output of the attention mechanism.

20. An information processing apparatus comprising:
first generation circuitry configured to perform a resolution reduction process on a target image to generate a low-resolution image, the resolution reduction process being a process in which a degree of resolution reduction changes depending on a size of the target image or a size of dispensable information contained in the target image; and
second generation circuitry configured to perform a process of generating, based on the low-resolution image, a super-resolution image having a predetermined resolution corresponding to a resolution of the target image.
